(19) United States
(12) Patent Application Publication
(10) Pub. No.: US 2016/0230516 A1
(43) Pub. Date: Aug. 11, 2016

(54) DEVICE FOR FIREFIGHTING AND CONTAINMENT OF OIL OR GAS FROM DAMAGED WELLHEAD OR PIPELINE BREAK

(71) Applicants: Vladimer Loladze, Tbilisi (GE); George Loladze, Tbilisi (GE); Nino Loladze, Tbilisi (GE); Vakhtang Loladze, Schwenksville, PA (US)

(72) Inventors: Vladimer Loladze, Tbilisi (GE); George Loladze, Tbilisi (GE); Nino Loladze, Tbilisi (GE); Vakhtang Loladze, Schwenksville, PA (US)

(21) Appl. No.: 15/013,933

(22) Filed: Feb. 2, 2016

(30) Foreign Application Priority Data
Feb. 5, 2015 (GE) AP2015013724

(51) Int. Cl. E21B 43/01; A62C 3/06; E21B 34/00; A62C 2/06; E21B 41/00; E21B 43/12

(52) U.S. Cl. CPC E21B 43/0122; E21B 41/0007; E21B 43/12; E21B 34/00; A62C 2/06; A62C 3/06

(57) ABSTRACT

The presented invention pertains to devices and techniques for containment of burning, as well as of non-burning, hydrocarbon energy resources blown out of a damaged wellhead or pipeline on the land or under water. The device can be monolithic or modular and assembled into a bell-shaped dome structure using a single or multi-layer flexible fire-proof material. Upper section of the dome has connected one or more flexible arms with attached ducts. The attached arms can be branched. The arms and their branches are used to divert fire flames and released products away from the affected area into a safe zone or a collection reservoir. The device can be deployed for containment and localization of the blown out resources from horizontal, vertical or inclined pipelines. Materials needed for fire suppression (e.g. gaseous or vaporous inert materials) or required for stopping and capping damaged area (e.g. concrete mixture) are delivered into the device via hoses or pipes passing through lateral openings of the device structure. The presented invention can be continuously utilized until the fire is extinguished or damaged area containment is achieved, thus providing enhanced environmental protection.

### CROSS REFERENCE TO RELATED APPLICATIONS

This application claims the benefit of Georgia (GE) Patent Application No. AP2015013724 filed on Feb. 5, 2015 and titled “DEVICE FOR FIREFIGHTING AND CONTAINMENT OF PRODUCTS BLOWN OUT OF A DAMAGED WELLHEAD OF A DRILLED BOREHOLE AND A BREAKAGE POINT OF A PIPELINE CARRYING HYRDROCARBON ENERGY RESOURCES”, which is herein incorporated by reference in its entirety.

### TECHNICAL FIELD

The present invention pertains to devices and techniques for containment of burning, as well as of non-burning, hydrocarbon energy resources blown out of damaged wellheads or pipelines.

### BACKGROUND

A known device which is made into a dome-like structure from a flexible fire-proof material has an opening in the upper portion with a connected duct for diverting flames and products blown out of a damaged borehole wellhead or pipeline. Such a device can be used both on a land (GE 2003 1034 U, A 61 C 2/06. G. Loladze, V. Loladze, Device for Containing of Fire, 10.11.2003, hereinafter “Reference 1”, which is herein incorporated by reference in its entirety) and under the water surface (GE P 2012 5448 B, A 61 C 2/06. V. Loladze, G. Loladze, N. Loladze, V. Loladze, Device for Firefighting and Containing of Products Blown out from Damaged Wellhead, 06.07.2010, hereinafter “Reference 2”, which is herein incorporated by reference in its entirety).

Application of such a device encompasses its placement onto a damaged area from which mined or transported products are blown out. The device (Reference 2) can be monolithic or modular assembled from individual elements/sections and has side openings with valves. These openings can be used for introducing inert gaseous or vaporous materials for fire extinguishing, or introducing a concrete mixture inside the dome or between layers of the flexible dome for blanketing the damaged area, as well as for regulating the pressure inside the dome. A lower edge of the device is comprised of a tubular sleeve which can be filled with a heavy material to create a seal between this device and the damaged wellhead or pipe. In order to maintain the flexible device geometry, stretching ropes or chains are fastened to the dome. These ropes are also used as guides to attach special submergible reservoirs, such as tanks/vessels and to direct them to a flexible duct for collecting and then hoisting products blowing out of damaged areas from the deep waters. At shallow depths, the blown out products are lifted to a water surface for collecting in floating devices or existing structure/containers using flexible duct itself (Reference 2).

The objective of the presented invention is to provide superior capability for protecting the environment from damaged borehole wellheads or pipeline bursts by extinguishing fire or achieving improved containment and continues and uninterrupted evacuation of energy resources blown out from damaged borehole wellheads or pipelines.

The technical effect of the presented invention is an enhanced environmental protection, increased ecological safety, increased operational efficiency and decreased probability of operational interruption while extinguishing fire and containing blown out resources from the damaged areas.

The presented invention can be deployed at horizontal, inclined or vertical pipelines extending from a borehole wellhead on the sea bed to platforms that receive energy resources on the water surface.

The technical effect can be achieved by covering damaged area with a flexible bell-shaped dome like structure made of a single or multi-layer fire-proof material, which is equipped with one or more flexible arms or one or more branched flexible arms. Each of the arms and their branches are equipped with interconnected valves or stoppers with individual on/off switches. They are also equipped with tools for changing their location arrangement and direction. Each arm or branch can be connected to a separate collection tank/vessel. Additionally, in case of damaged vertical or inclined pipeline one of the sections of the dome has a circular cut out in order for the dome to be positioned over and/or wrapped around a damaged area. The circular hole also can be attained by joining two separate sections of the dome around the pipeline which have half circular cut outs during its assembly around a pipeline. When the circular hole is part of a single section there is a cut between the hole and the edge of the section which is fastened after placing the section and the dome around the pipeline. In order to insure a tight seal between the dome and a pipeline the cut out hole is equipped with a ring shaped collar which allows fastening or sealing of the dome structure hermetically around an inclined or a vertical pipeline.

The above described arrangement of arms and their branches with valves enables the presented device to collect blown out material continuously by automatically switching between filled and empty collection reservoirs in a tandem or simultaneous sequence, thereby minimizing or completely preventing emission into environment.

The presented device can be equipped with a pump within the flexible arms that can increase the flow rate of products released from a damaged pipeline. The pump can be utilized in combination with an emulsifier to disperse coagulated hydrocarbons. The pump can also be utilized in combination with a crashing and milling tools for converting crystalline hydrates back into water and gas.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system for extinguishing fire and diverting energy resources about a damaged wellhead or pipeline is provided. The system comprises a bell-shaped, dome-like structure comprised of a single or multi-layer flexible fire-proof material, the structure having at least one regulation hole therethrough for regulating pressure or fires therein; a flexible arm in fluidic engagement with an apex of the structure for receiving flow from within the structure; and at least two branching arms in fluidic engagement with the flexible arm, wherein each of the branching arms is further in fluidic engagement with one of at least two distinct collection units, and wherein each of the branching arms includes an arm device for manipulating contents of the flow from the flexible arm.

According to at least embodiment, an alternative system for extinguishing fire and diverting energy resources about a damaged wellhead or pipeline is provided. The alternative system comprises a bell-shaped, dome-like structure comprised of a single or multi-layer flexible fire-proof material, the structure having at least one regulation hole therethrough for regulating pressure or fires therein; at least two flexible arms in fluidic engagement with an apex of the structure for receiving flow from within the structure, wherein each of the flexible arms is further in fluidic engagement with one of at least two distinct collection units; and wherein each of the flexible arms includes an arm device for manipulating contents of the flow and a compensator for positioning the flexible arm.

According to at least one embodiment, a method of extinguishing fire and diverting energy resources about a damaged wellhead or pipeline is provided. The method comprises positioning a bell-shaped, dome-like structure comprised of a single or multi-layer flexible fire-proof material about the damaged wellhead or pipeline; regulating pressure or fires within the structure by supplying inert materials and/or concrete mixtures through at least one regulation hole of the structure; receiving flow from the damaged wellhead or pipeline through a flexible arm in fluidic engagement with an apex of the structure; collecting the flow in at least two distinct collection units through at least two branching arms in fluidic engagement with the flexible arm; and an arm device of each of the branching arms manipulating contents of the flow from the flexible arm.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

The device for diverting the energy resources blown out from a damaged wellhead of a borehole and for aiding in fire extinguishing is depicted in 15 figures, wherein:

FIG. 1 shows a general view of the flexible bell-shaped dome consisting of individual sections;

FIG. 2 shows a common view of a piece of the flexible bell-shaped dome consisting of individual sections;

FIG. 3 shows top view of a trapezoidal section of the flexible bell-shaped dome with a cut-out circular hole and a cut for inclined or vertical pipeline;

FIG. 4 shows top view of two adjacent trapezoidal sections of the dome with a semicircular cutout on each of the sections for assembly around an inclined or vertical pipeline;

FIG. 5 shows the cross sectional view of the flexible bell-shaped dome installed at a low depth under water surface with one arm and multiple branches;

FIG. 6 shows the front view of the flexible bell-shaped dome mounted on a damaged inclined or vertical pipeline;

FIG. 7 shows a cross sectional view of the flexible bell-shaped dome suspended over a damaged point of a vertical pipeline;

FIG. 8 shows a front view of the flexible bell-shaped dome without any devices that is suspended on a vertical pipeline;

FIG. 9 shows a cross sectional view of the flexible bell-shaped dome installed at a deep depth having a branched arm. Schematically shown are submersible tanks lowered using guides from the offshore surface towards the arm as well as their locations while being submerged and loaded, i.e. at the end of the arm filled by blown out products, and unloaded, i.e. discharged—by pumping out collected products into a tanker or on an offshore water structure or in a special floating means fixed on the water surface;

FIG. 10 shows a cross sectional view of the presented invention when it is deployed for extinguishing fire caused by flaming products coming out of a damaged pipeline. Delivery of gaseous or vaporous inert materials into the flexible bell-shaped dome from outside using pipes or hoses passing underneath its sealing sleeve and through side opening are also shown;

FIGS. 11-14 depict remote deployment of the presented invention during fire extinguishing. The device is remotely placed over the affected area to suppress fire and aid in its extinguishing;

FIG. 11 shows a side view of how the device is guided towards and placed over a damaged area using anchors and guiding cables;

FIG. 12 shows a top view of what is shown in FIG. 11;

FIG. 13 shows a cross sectional view of the device guided and placed over the damaged area prior to lowering it;

FIG. 14 shows a cross sectional view of the device lowered and placed over the damaged area using additional weights. Pipelines passing through side openings of the device carrying gaseous and vaporous inert materials into the flexible dome for fire extinguishing are also shown;

FIG. 15 shows a cross sectional view of deploying the device from a floating platform or other floating means with a mounted large collection vessel. Filled transporting tanks/vessels with blown out material are raised to a safe zone using guiding cables and unloaded. The tanks/vessels are then submerged and used for the next load/unload cycle. Also shown on FIG. 15 is a device mounted on the platform that fixes the location of docking platforms at proper depth. Additionally, there are transporting tank/vessel delivery height limiters attached to the guiding cables;

FIG. 16 shows suspended two layer flexible dome over a damaged area with a steel framework and a capping arrangement place over the damaged well. The device is used as a flexible scaffold for pouring concrete;

FIG. 17 shows side view of a capping arrangement (consisting of a round shaped steel frame attached welded to two sections of pipes (49) with a valve (21) in between them) placed over a damaged wellhead;

FIG.18 shows deployment of the device as a flexible scaffold ready for the concrete pouring steps. The flexible dome is tightly sealed to the sea bed. The capping arrangement with shut off valve (21) is placed over the damaged wellhead and hoses/pipes (54) required for pouring the concrete are passing through lateral openings of outer dome. The shut off valve is in open position. The blown out material is passing freely through steel frame (48) and the open valve (21), and is evacuated through flexible arm (4);

FIG. 19 shows damaged valve under poured concrete layers with an open shut off valve in the capping arrangement;

FIG. 20 shows damaged wellhead under concrete layers poured both inside and outside of the flexible dome and an additional payload of heavy gravel (58) placed over the outside concrete layer (57). The shut off valve in the capping arrangement is closed;

FIG.21 shows damaged pipeline under concrete layers with a capping arrangement (containing shut off valve) placed over the damaged area;

FIG. 22 shows the flexible dome with a suspended capping arrangement inside the dome being placed over a damaged wellhead. The capping arrangement has welded conical shaped steel frame;

FIG. 23 shows a capping arrangement with a welded conical shaped steel frame placed over a damaged wellhead.

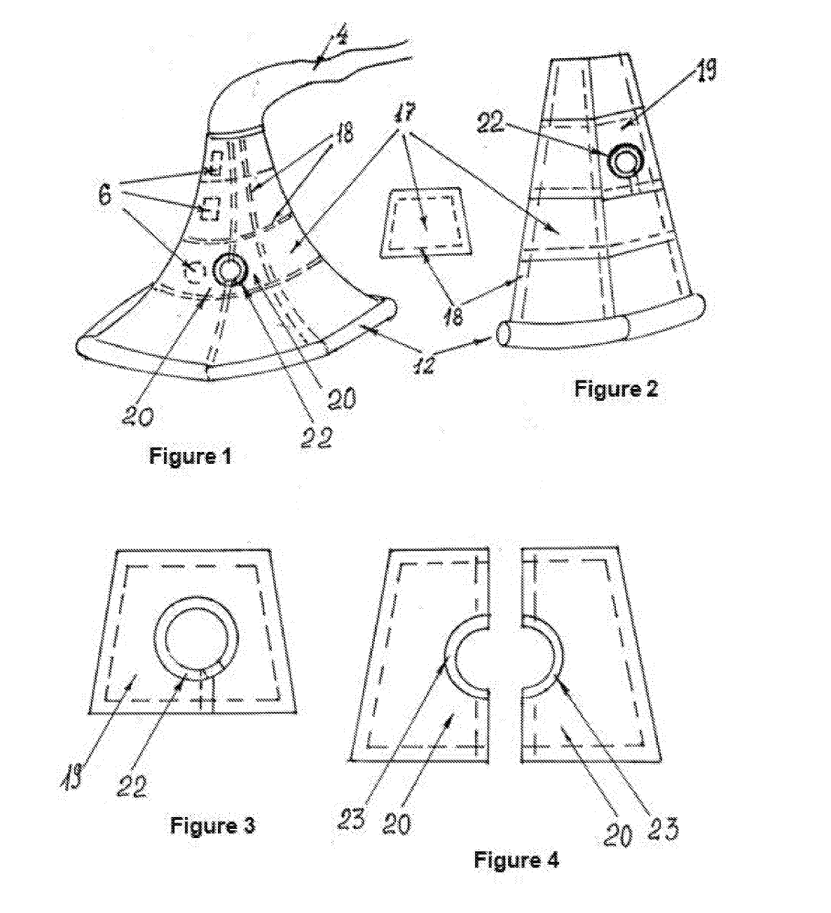

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Below are listed referenced numerals assigned to structural elements of the device represented in the figures above and described herein:

1—Flexible bell-shaped dome;

2—Assembling frame fastened to the lower part of the flexible bell-shaped dome for stabilizing its location when lowering;

3—Pump intended for increasing the flow rate of the product coming out of a damaged pipeline. The pump can be utilized in combination with an emulsifier for dispersing of a coagulating portion of materials released into the water. Moreover, the pump may also be utilized in combination with crashing and milling tool for milling the crystalline hydrates created as a result of throttling effect (that causes rapid cooling of methane that come along the extracted oil, which is accompanied with pressure drop when fluid irrupts from a damaged pipe. The pump may be utilized in combination with both emulsifier and crashing/milling tool as well. Tools that are capable of converting the crashed or non-crashed crystalline hydrates back into water or gas may also be utilized in combination with the above listed devices. Pumps can be installed in more than one arm or arm branch as needed.

4—Flexible arm connected to the upper section of the flexible bell-shaped dome intended for raising products discharged from a damaged pipeline or a borehole wellhead to the surface, and for diverting burned products away from a damaged area while using the device for extinguishing a fire.

5—Stabilizing loads that are fastened to the frame—anchors;

6—A hole made in the body of a dome for attaching a valve for regulating pressure within the dome during the pump operation and for feeding a gaseous or vaporous inert materials into the flexible dome during fire extinguishing;

7—Depicts flow direction of products released from a damaged pipeline or a borehole wellhead, or flow direction of burning products during a fire;

8—Damaged pipeline or a borehole wellhead;

9—Floating device/watercraft for submerging and holding of the flexible bell-shaped dome under the water surface;

10—Compensating means on the arm for adjusting the location of the arm neck during wavy waters;

11—Stretching cable or chain attached to the flexible dome. One end of the cable or chain is connected to the sea bed and the other end to the floating device (9). The cables or chains together with the frame (2) are maintaining the flexible dome shape and retaining the entire system at a desired place. The cables or chains are also used as guides and retainers for transporting tanks/vessels between the loading and unloading points during their submerging and raising operations.

12—A tubular sleeve attached to the lower contour of the dome that is filled with heavy material such as sand, metal pieces, heavy clay solution and/or other similar combinations of heavy materials for tightly placing the flexible dome against the sea bed or the ground surface. More than one sleeve can be attached in horizontal tiers around the flexible dome contour to insure its tight placement against the affected area surface.

13—Cable or chain fastened at one end to the stretching cable (11), and with its other end fastened to the flexible dome to stabilize the flexible dome's bell-shaped structure in the deployed state. The mentioned cables or chains are placed in horizontal tiers within the dome's height limits from its lower section up to the upper section. The entire spatial system of interconnected chains or cables (11) and (13), and the frame (2) ensures that the dome (1) is stable during submersion and in its operational state;

14—Holding and retaining means for the flexible arm neck placed on the water surface;

15—Cable or chain for connecting the flexible dome to the frame and stabilizing load;

16—Power Cable for the pump and emulsifier device;

17—Trapezoidal section, part of the modular and flexible dome structure;

18—Uncoupling stitch of the modular and flexible dome section;

19—The modular dome section with a cut-out circular hole with a hermetically sealing ring-shaped collar for deployment on a vertical or inclined pipe;

20—Section with semicircular cut-out and half-ring of a hermetically sealing collar;

21—Valve or stopper;

22—“Collar” for hermetically sealing the flexible bell-shaped dome around inclined or vertical pipeline;

23—Half-ring of a hermetically sealing collar;

24—Arm branches;

25—Power cable for valve or stopper device;

26—Frame for fixing the arm branches;

27—Bottomless tanks/vessels—for collecting and transporting products released from a damaged pipeline or a borehole wellhead to water surface. The tanks/vessels are provided with ballasts to ensure their orientation in space with the opened bottom at lower side. Lifting of tanks/vessels to the surface is accomplished by gained positive buoyancy when tanks/vessels are filled with air or oil. If necessary, the raising and submerging rates of the tanks/vessels can be regulated by applying external forces;

27-I—Denotes position of the water-filled transporting tank/vessel while it's being lowered to the filling site;

27-II—Denotes position of a transporting tank/vessel while it's being filled with products released from a damaged area;

27-III—Denotes position of a transporting tank/vessel while it's being unloaded—the product contained and collected from a damaged area is being transported to the water surface and being transferred to a large collection vessel/reservoir;

28—Guide for transporting tanks/vessels (27) while moving along cables (11);

29—A platform or a watercraft with a large reservoir for collecting blown out products from a damaged pipeline or borehole wellhead which were delivered by bottomless tanks/vessels (27);

30—Transferring means—e.g. a hose for transferring products raised to the water surface by bottomless tanks/vessels (27) into a large collection reservoir;

31—Water that is being fed into the bottomless tanks/vessels while they are being unloaded (during transferring of the blown out products into a large reservoir on the water surface);

32—Water that is displaced by blown out products during filling of the bottomless tanks/vessels (27);

33—A pipe or a hose for feeding gaseous or vaporous inert materials into the dome;

34—Connecting hinges for assembling the frame (2);

35—Pulling cable connected with one end to the frame (2), and with the other end to a pulling mechanism for moving the device towards a damaged area;

36—Braking cable connected with one end to the frame (2), and with the other end to a braking mechanism;

37—Anchor for attaching supporting and guiding cables (38) to the sea bed;

38—Supporting and guiding cables for remotely moving the bell-shaped flexible dome and placing it over the damaged area.

39—Tool or cable for fixing the direction and location of the arm and/or branches and thereby changing the direction of emitted burned products;

40—Extra load that is attached to the bell-shaped flexible dome in parallel to the tubular sleeve (12) if needed;

41—A pipe or a hose attached to the bell-shaped flexible dome prior to moving it towards the fire source. It is used for remotely feeding gaseous or vaporous inert materials into the dome for extinguishing fire similar to pipe (33) passing through the hole (6);

42—Depicts possible change in the direction of the arm location by a device or the cable (39);

43—Fire source;

44—A docking platform for bottomless tanks/vessels (27) with attached guiding cable (11);

45—A device mounted on the platform or watercraft (47) to ensure that the docking platform (44) is fixed at a required depth;

46—The bottomless tank/vessel (27) delivery/raising height limiter;

47—Offshore platform or watercraft with attached devices (45) and a large reservoir for receiving and collecting products transported from damaged areas using the bottomless tanks/vessels (27);

48—Steel frame;

49—Pipe sections;

50—Inner layer of the dome;

51—Steel mesh;

52—Surrounding weighing ring;

53—Circular brace (e.g., made of steel) for protecting capped well from damage caused by hydraulic knock while closing valve (21) to stop the flow of blown out material. Also used during concrete pouring to insure conical shape of the outer dome;

54—Pipe or hose used to deliver concrete mixture into interlayer space through lateral opening/valve;

55—First layer/tier of the poured concrete;

56—Second layer/tier of the poured concrete;

57—Concrete layer for applying extra weight;

58—Gravel for applying extra weight;

59—Connectors for suspending capping arrangement (60) inside the inner dome. The connectors can be flexible (e.g. steel cables or chains) or rigid (e.g. hinges or telescopic rods with spring loaded partitions);

60—Capping arrangement consisting of a conical shaped steel frame welded from one side to two sections of pipes (49) with a shut of valve (21) in between them.

The presented invention has superior capability for protecting the environment than the prior art described in References 1-2. It is versatile and can be deployed continuously until the fire is extinguished and/or the leakage from the damaged area is contained. The flexible and modular nature of the device allows it to be used both on the land and under the water surface at significantly different depths. It can be assembled and disassembled nearby or at the point of use in different configurations and rapidly deployed. Also, because of its modular nature, the device can be stored, transported and repaired more affordably and efficiently. Under the water surface the device can be used for damaged wellheads as well as pipelines. In case of pipelines, the modular nature of the device allows it to cover not only a damaged pipeline on the sea bed but also to be assembled around damaged vertical or inclined underwater pipelines that are above the sea bed.

In order to contain and safely evacuate products blown out of a damaged borehole wellhead and pipelines, the damaged areas are covered with a bell-shaped flexible dome (1) having at least one flexible arm (4) with a connected duct on its upper side, which in turn can be branched (24). Each arm and/or branch are equipped with valves or stoppers (21) that are interchangeably connected to one another with the capability of being automatically switched on and off in accordance to a loading-unloading scheme for bottomless tanks/vessels (27).

The tanks/vessels (27) are submerged and lowered from offshore platforms or watercrafts (47) to the loading points near one or more than one arm or their branches which can be arranged in parallel to each other. After arriving at the loading point, the valve (21) mounted on an arm or its branch is switched on with a switching device and the tank (27) is filled up with the blown out material. Upon filling completion, the valve is switched off and the tank moves away from the loading point and raises to the water surface using positive buoyancy and external force if needed. While the first tank is being filled a second tank has been submerged to the second loading point (arm or its branch). As soon as the first tank is filled, the valve at the second loading point is automatically switched on and the blown out product evacuation process continues. One or more transporting tanks/vessels (27) can be filled in alternating or simultaneous manner using one or more than one arm and their branches which allows maintaining continuity of the process in order to accommodate large amounts of product released from the damaged areas. The delivery rate of the tanks to the loading area, and their raising rate can be set depending on a depth of a damaged area, the tank volume, number of loading points and amount of products blown out per unit of time.

The bell-shaped flexible dome is assembled using trapezoidal sections (17). Assembly of the dome around vertical or inclined pipelines can be accomplished utilizing a single section with a cut-out circular hole (FIG. 3) or two pairing sections with a semicircular cut-outs on the facing sides (FIG. 4). A tight contact of the flexible dome around the pipelines is achieved by attaching the half-rings (23) of a hermetically sealing collar (22) in the case of two pairing sections (FIG. 4) or by attaching a hermetically sealing collar to the cut-out hole in a single trapezoidal section (19). In the latter case there is a cut between the hole and the edge of the section (FIG. 3) which is stitched or fastened after placing the section around the pipeline.

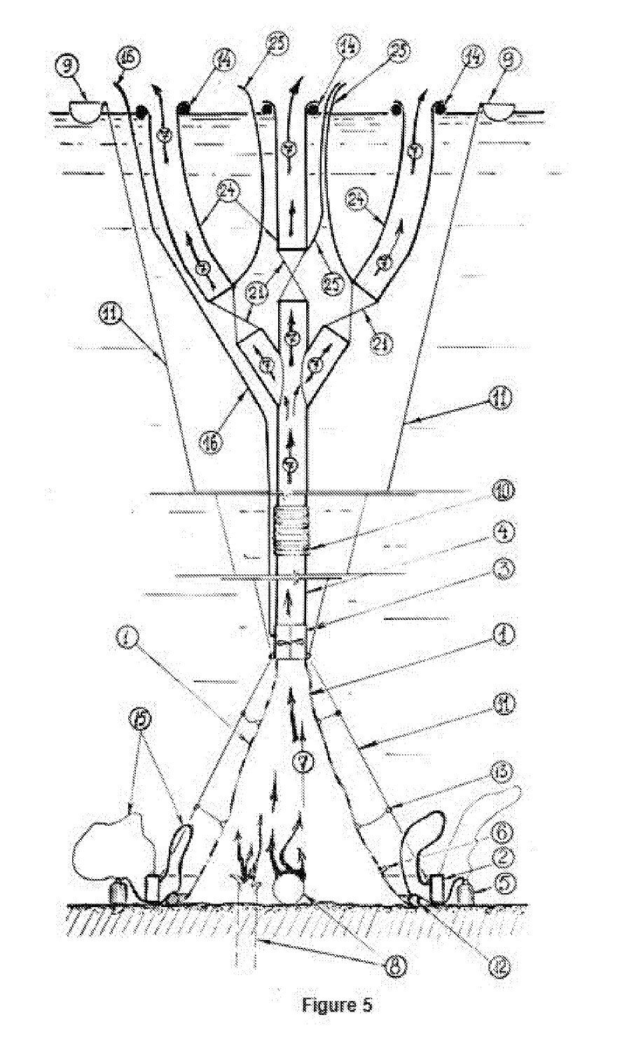

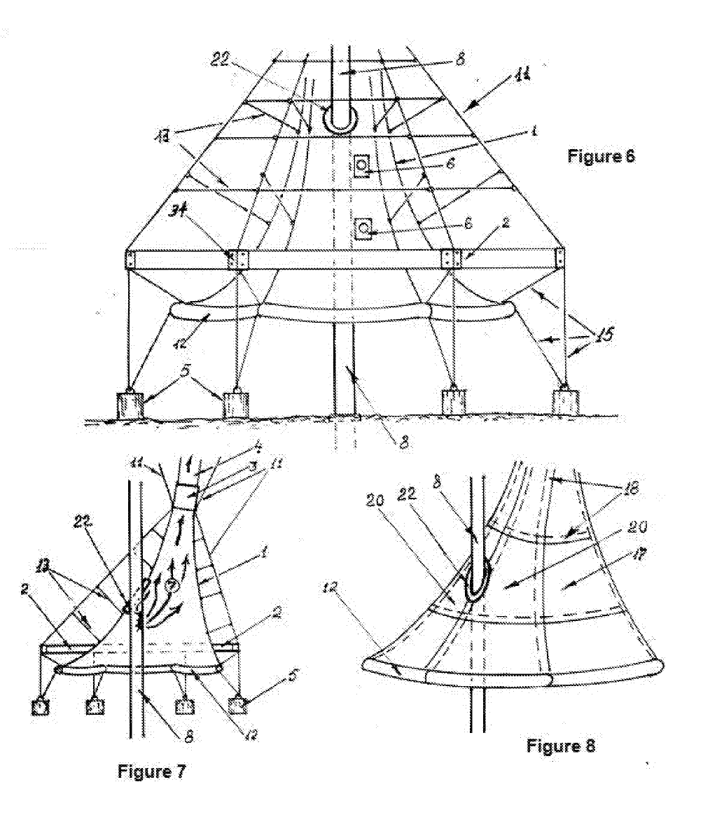

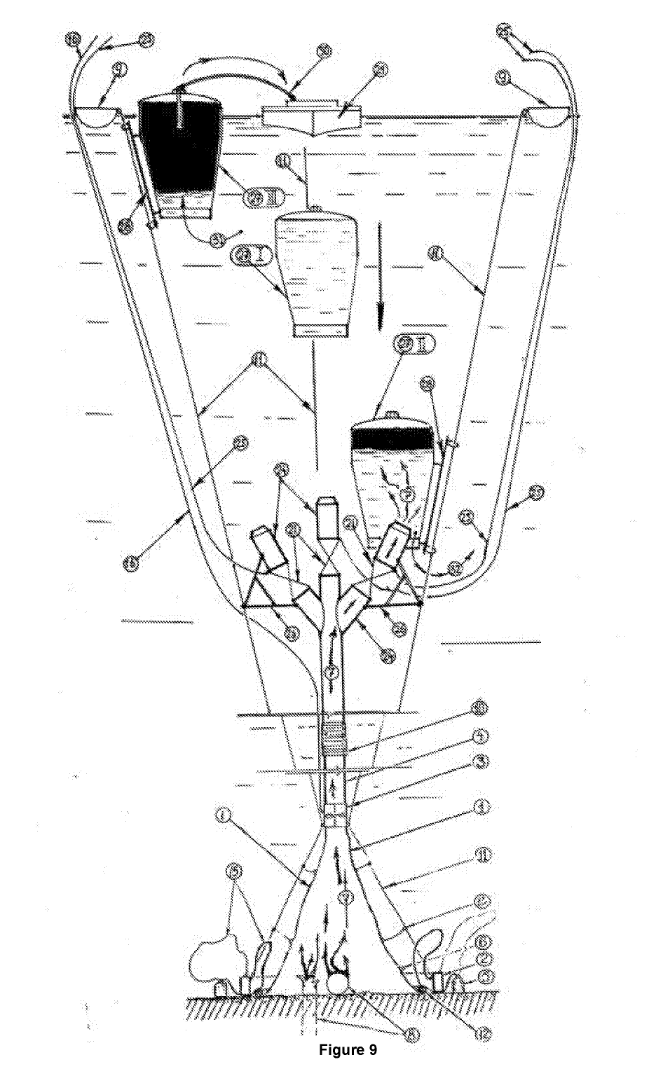

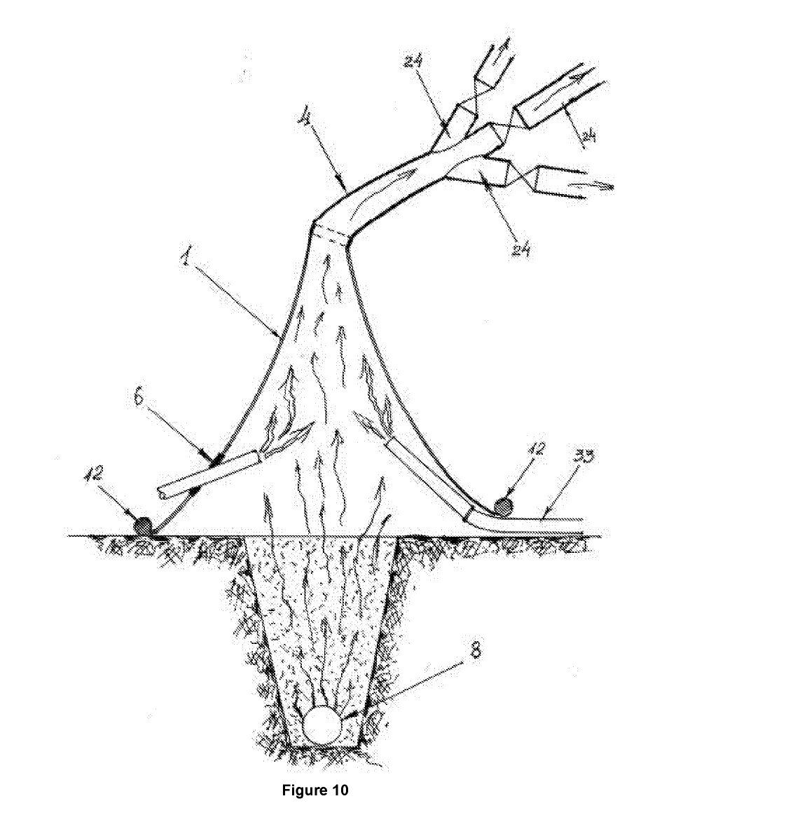

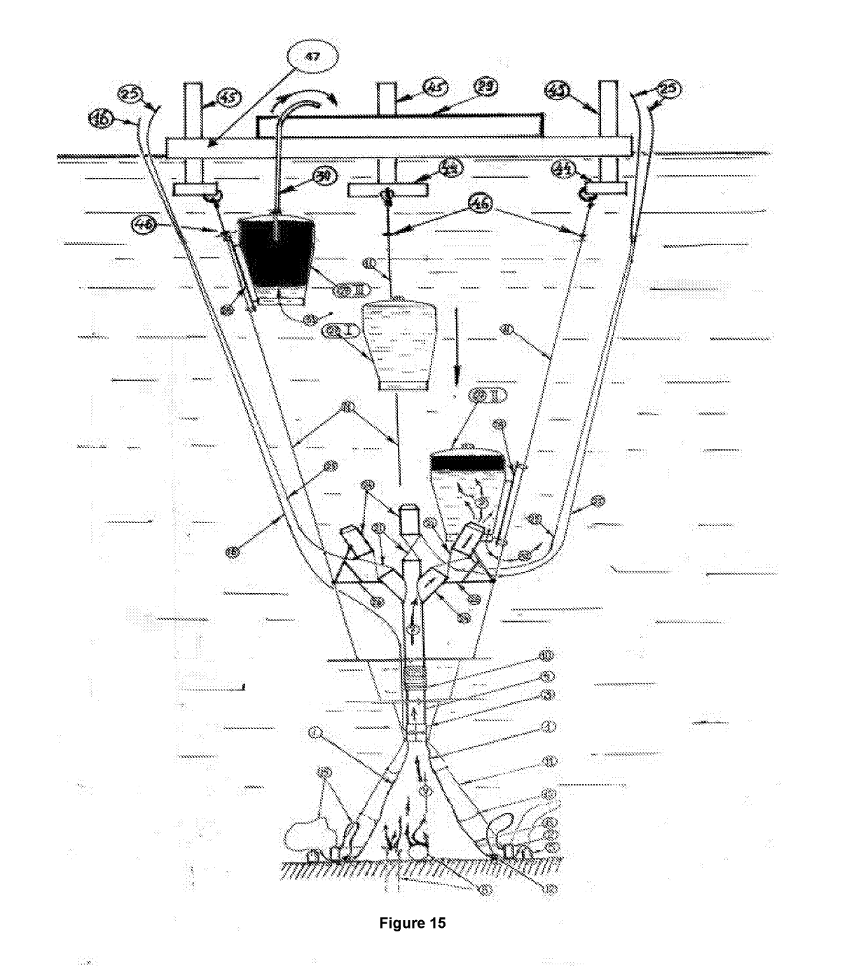

If the damaged area is located at relatively low depths, the presented invention allows for blown out material to be transferred via ducts connected to arms (4) or their branches (24) into collecting reservoir directly on the water surface (FIG. 5), and at the significantly deeper depths the material is transferred using tanks (27) as described above (FIGS. 9 and 15).

To use the presented invention on damaged inclined and vertical pipelines (8), the flexible dome (1) is fastened on the pipe such that the later passes through the dome wall. In this case, the dome can be assembled by coupling individual elements directly with the pipe, or the already assembled dome can be placed onto the inclined or vertical pipe.

The flexible dome is assembled on the pipeline at an accessible place, e.g. over or underneath the damaged point. Initially, sections (20) with sealing collar are mounted on the pipe, then the entire dome is assembled and guided along the pipeline towards a damage point and positioned such that blown out material is captured within its flexible structure and directed through ducts connected to one or more arms (4) or branches to a collection reservoir on a platform or a watercraft on the water surface.

When deploying already assembled flexible dome (1) onto an inclined or a vertical pipe, it is moved to the pipeline at an appropriate height from the sea level. The dome is brought to the installation point from the placing side—i.e. the side with the cut-out hole and sealing collar. Then the frame (2) is partially dismantled temporarily: connecting hinges (34) are removed, cables and chains (13) are removed as needed, and seams on the uncoupling stitches (18) and the collar (22) are opened. Then the flexible dome is placed on the inclined or vertical pipeline, the collar fastened and the coupling stitches closed and all the temporarily removed parts are joined back.

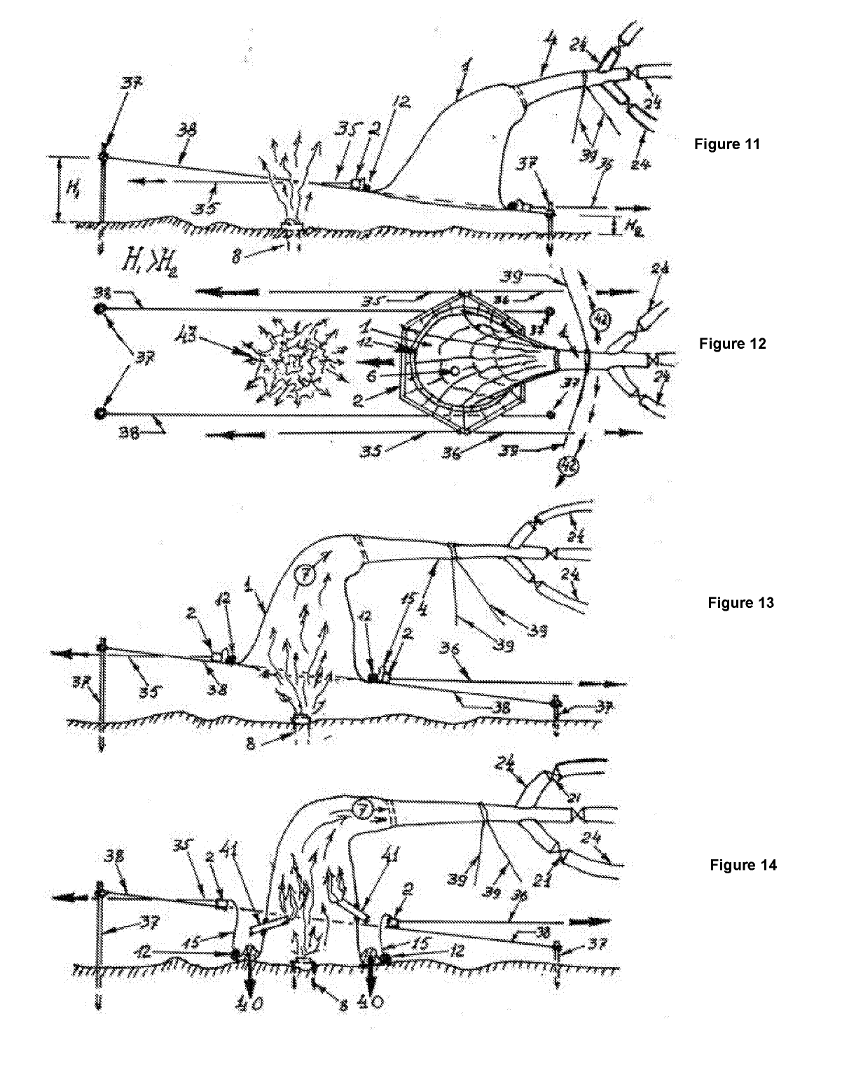

While extinguishing a fire, using fixed arm configuration the flow direction of the burning products (7) and released materials (7) can be changed using multiple branches (24) of an arm or arms. Automated control of valves (21) installed in each branch will help to control flow and maintain continuity of released material containment, evacuation and collection. The position of the arms can be changed as well using a device or cable (39) shown in FIGS. 11-14. As described above (FIG. 10), during fire extinguishing gaseous or vaporous inert materials are fed into the flexible dome through pipes or hoses passing through side holes or underneath the sealing sleeve attached to the dome contour. If needed, the sealing sleeve can accommodate multiple pipes or hoses to increase amount of delivered gaseous or vaporous inert materials.

Having ducts connected to one or more branched arms insures continuity of the operation in case one of the branches is damaged by materials used for firefighting fed from outside e.g. concrete mixture. In such cases, the valves (21) mounted on arms (4) or their branches (24) ensure automatic switching from one branch to another, thereby, insuring continuous containment, evacuation, and collection of products blown out from damaged points.

Continuity of the operation during the device deployment can be also achieved under stormy conditions with strong waves or under cold and icy conditions. In these cases the guide cables (11) can be fastened to underwater docking platforms (44) that are controlled from a platform or a watercraft (29) on the water surface by means of special devices (45) (FIG. 15). During bad weather conditions, these devices fix the underwater docking platform at an appropriate depth to allow receiving the blown out products in a safe zone below the water surface.

The presented invention also can be used for raising of gases, such as methane, hydrogen sulfide and alike, that leak at low depths from cracks and fractures on the bottom of sea bed. Also, the device can be used for raising of natural resources, including air hydrate crystals, along with sediments from the sea bed stirred up by a jetting action. This can be achieved by covering a place for collecting products on the bottom of sea bed with the flexible dome and turning on a pump (3) of an appropriate power installed within the flexible arm (4).

The novel features of the present device can be applied to the device described in Reference 2, which can be utilized as a flexible scaffold for capping of a damaged wellhead or pipeline during a repair work. Utilizing the unique features of the present device, the blown out materials can be more efficiently directed away from the damaged area under the water surface.

Capping of a damaged wellhead or pipeline on the sea bed using multilayer flexible dome can be achieved in the following manner. Inside of a properly sized flexible dome is placed an additional layer of flexible material (e.g., fiberglass) which will form so called inner dome (50). The multi-layer dome may be assembled by casing the main dome with another flexible dome. The outer dome structure is protected by a mesh (e.g., by a steel mesh (24)). In order to stabilize the location of the dome the mesh can be fastened to the stabilizing frame (2) or to a heavy ring (52) which is attached to the lower contour of the outer/protective dome.

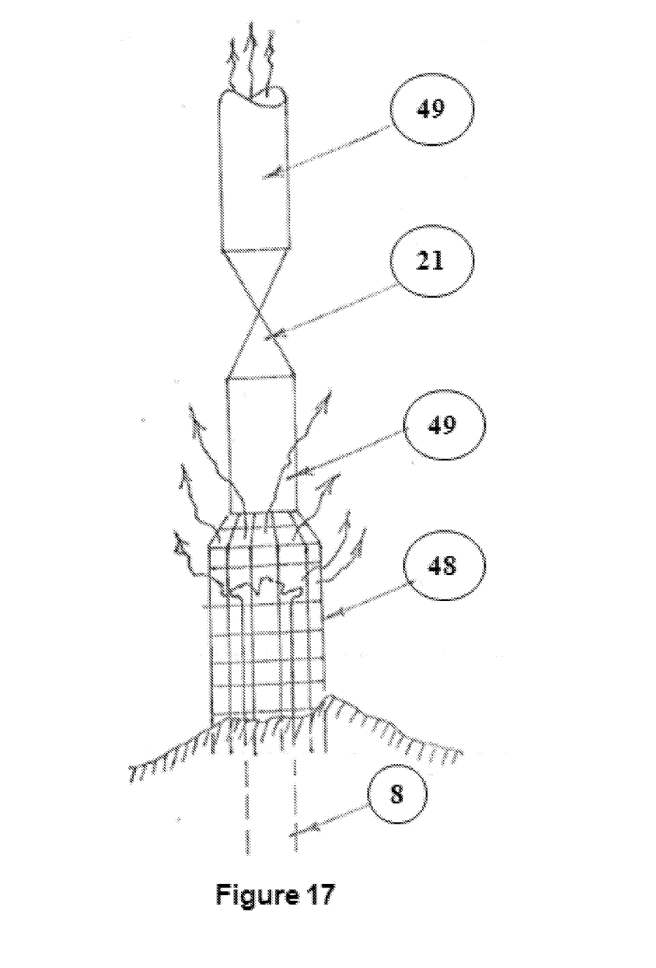

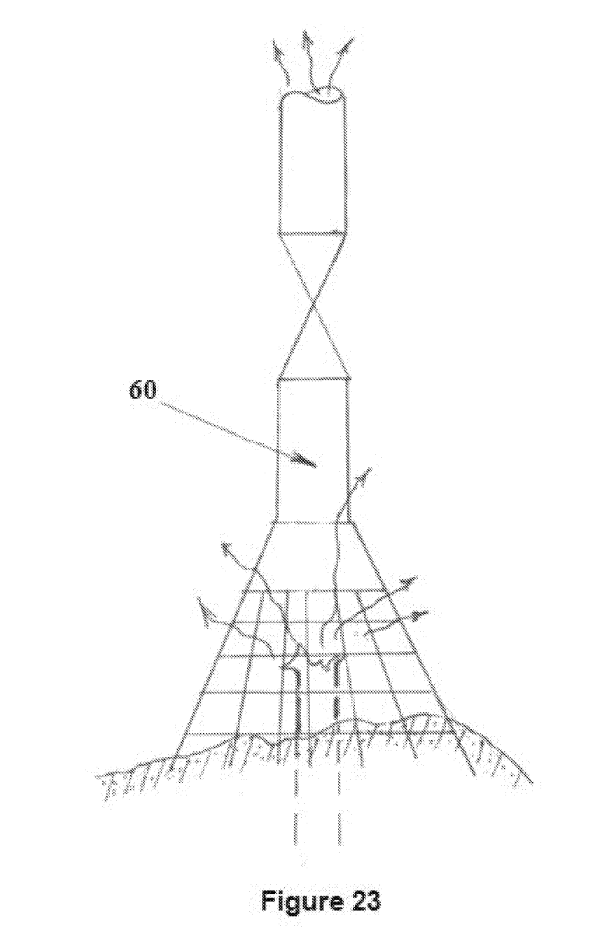

The device in this configuration is placed above the damaged area to direct blown out material to a collection point. At the same time the area around the damaged wellhead is deepened within the limits of coverage area by the flexible dome sleeve (12). The wellhead is covered with a capping arrangement comprised of a round or conical shaped steel frame (48) which has welded from one side two sections of pipes (49) with a shut off valve (21) in between them (FIGS. 17 and 23). The valve can be closed or opened remotely.

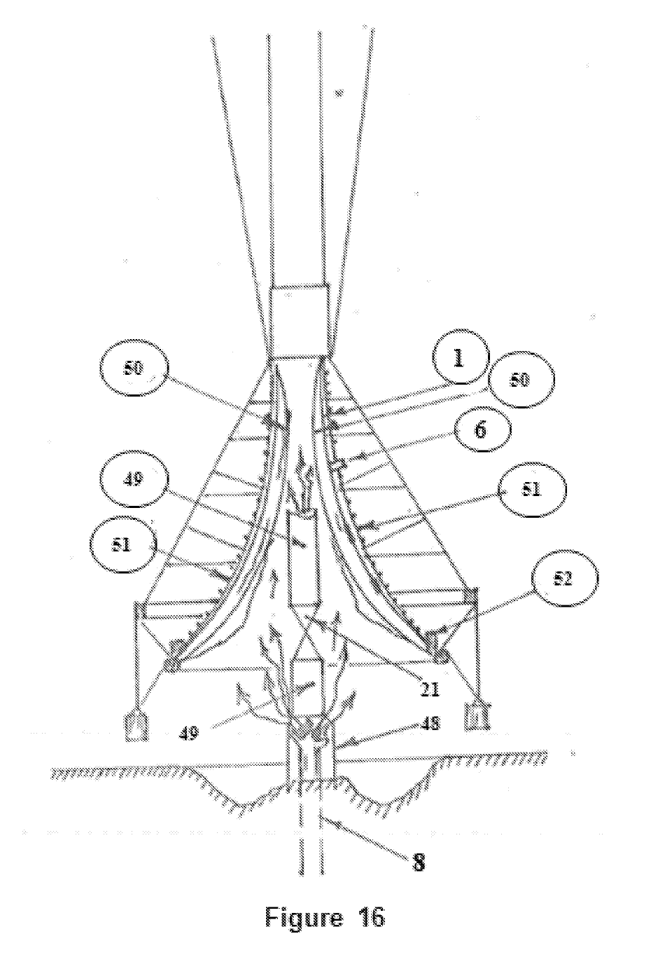

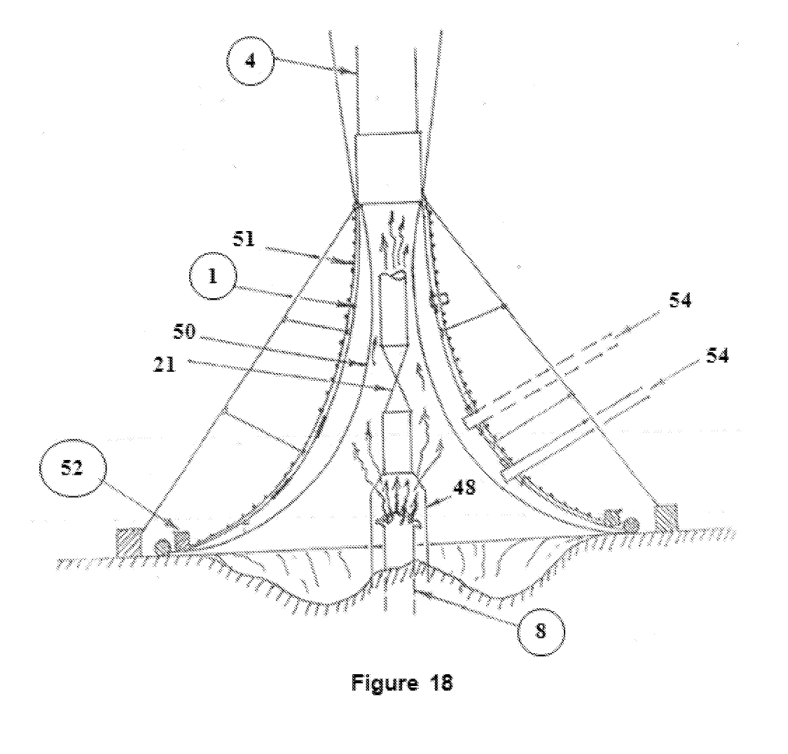

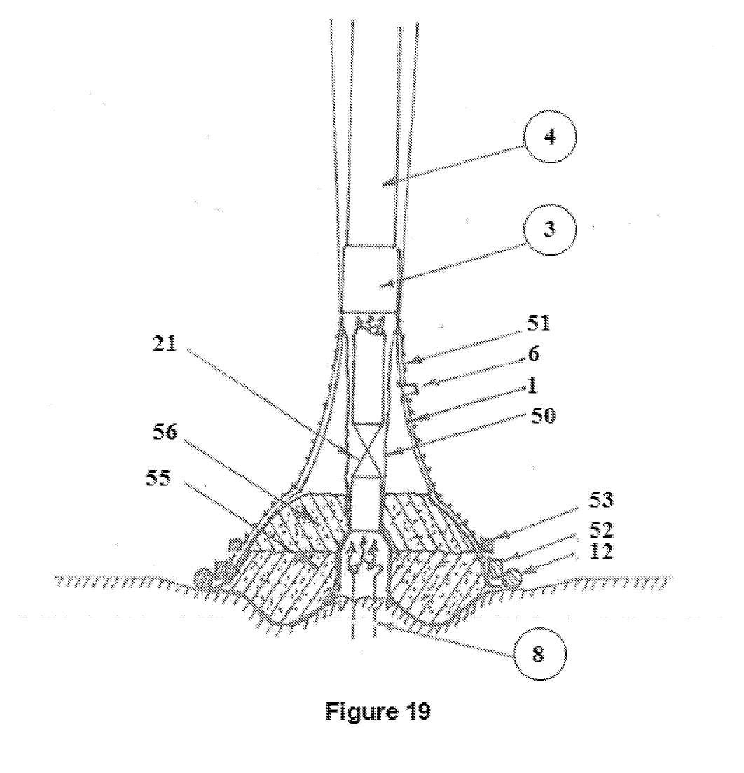

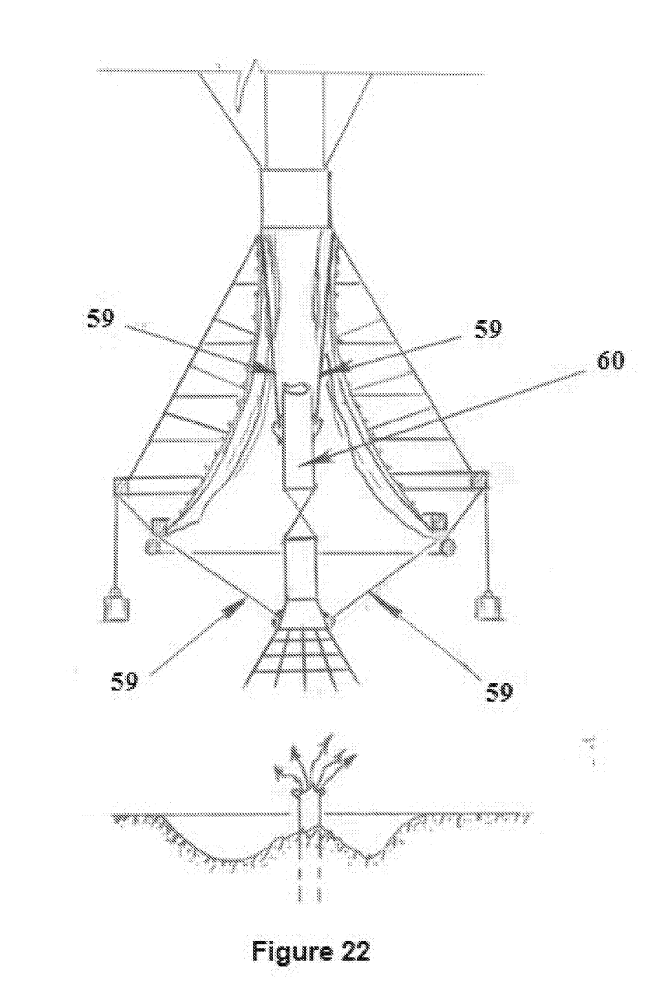

Prior to lowering the capping arrangement it is suspended inside the dome structure with the steel frame pointing down first (FIG. 22). The flexible dome with a suspended capping arrangement is lowered until its bottom touches the sea bed and covers the damaged wellhead at the same time directing the blown out material to a collection point (FIGS. 16 and 18). Then the space between the inner and outer dome layers is filled stepwise with a concrete mixture which may have different fillers (e.g., steel fillers) to increase its strength (FIGS. 18 and 19).

Before introducing the concrete mixture between the layers, the dome's location and integrity can be checked by filling the space between the layers with the water and then with a concrete mixture. In order to insure conical shape of the dome while the concrete is poured and to avoid ruptures of the concrete casing from a hydraulic knock during the shut off valve (21) closing, an additional steel circular brace (53) is incorporated in the second tier of the poured concrete from the outside of the dome. The diameter of this circular brace is smaller than a diameter of the heavy ring (52) in a lower tier. The number of the strengthening circular steel braces can be increase as needed to insure structural integrity of the concrete casing after the valve (21) is closed.

The shut off valve (21) stays open during the device placement and until the concrete pouring process is complete and the concrete is cured reaching a required strength. After the dome structure is secured to the sea bed, the space between inner and outer domes is filled with a concrete mixture in layers covering the inner dome bottom, pushing it against the capping arrangement (48) and filling up the space inside the dome with the concrete.

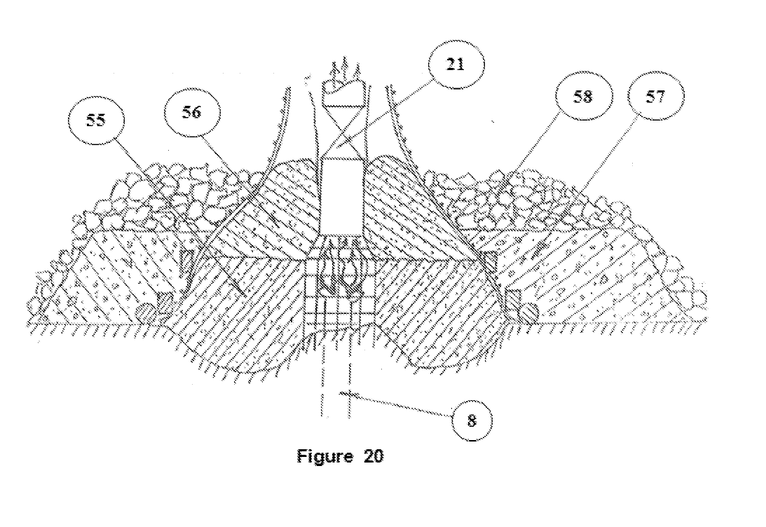

The concrete is introduced into the interlayer space through lateral opening(s) on the dome using hoses or pipes (FIG. 18). The lateral openings can be used for placing vibrators as well if needed. After the capping arrangement is fixed in place and the filled concrete cures, the concrete is poured from outside of dome (FIG. 20) and steel ring (52) and circular braces (53) are incorporated as described above.

Additional heavy material (e.g., heavy gravel, rocks, etc.) can be laid or poured from outside the dome all the way up to shut off valve (21) level (FIG. 20). This may be required because of strong underwater currents or high pressure of the blown out materials. The thickness of layers (55) and (56), and concrete and gravel (57, 58) weights are determined taking into account sturdiness requirements for the wellhead cap.

A capped damaged wellhead schematics is shown in (FIG. 20). After all the layers of the concrete (inside and outside of the device) are cured and the concrete is hardened into a unitary capping structure, the shut off valve (21) is slowly closed and the flow of the blown out material is stopped.

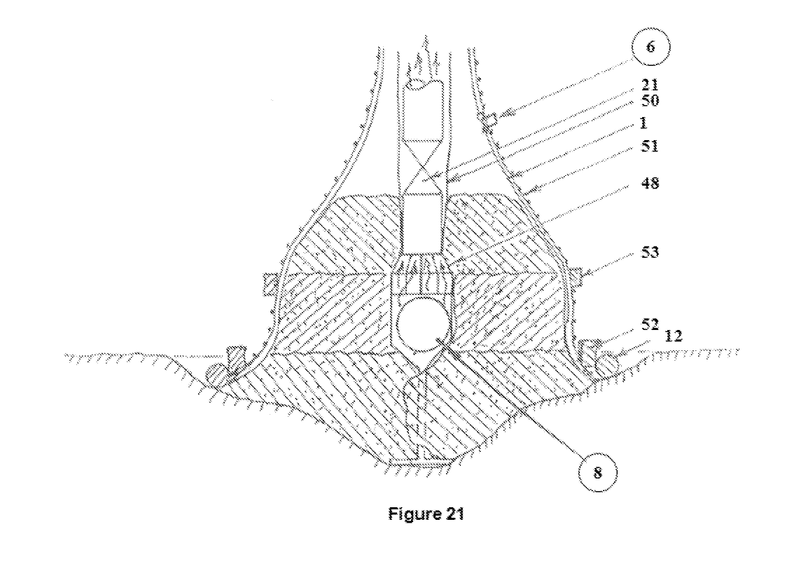

The same approach can be used for capping of a damaged pipeline. In this case the space under the pipeline is also cleared/washed away for laying concrete over a larger area and insuring a proper hermetic sealing (FIG. 21).

Finally, utilization of a system of interconnected arms, their branches and valves in the presented devices, as described above, allows continuous containment, evacuation, and collection of products blown out from damaged points which in turn minimizes or completely eliminates danger of spreading of the blown out products into the environment.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

The invention claimed is:

1. A system for extinguishing fire and diverting energy resources about a damaged wellhead or pipeline, comprising:
a bell-shaped, dome-like structure comprised of a single-layer or multi-layer flexible fire-proof material, the structure having at least one regulation hole therethrough for regulating pressure or fires therein;
a flexible arm in fluidic engagement with an apex of the structure for receiving flow from within the structure;
at least two branching arms in fluidic engagement with the flexible arm; and
at least two collection units for collecting the flow from the at least two branching arms,
wherein each of the branching arms includes an arm device for manipulating flow rate and/or contents of the flow from the flexible arm and a compensator for positioning the flexible arm and the branching arms.

2. The system of claim 1, wherein the structure further includes a circular pipe hole having a collar for hermetically sealing the structure about the damaged pipeline.

3. The system of claim 1, wherein:
the structure is modular and is further comprised of a plurality of sections coupled to each other using stitching, and
the structure further includes a circular pipe hole having a collar for hermetically sealing the structure about the damaged pipeline, and
two of the sections include semi-circular cutouts having semi-circular collar sections which, when the two sections are adjoined, form the pipe hole.

4. The system of claim 1, wherein each arm device includes a valve for regulating flow from the flexible arm and/or amongst the branching arms.

5. The system of claim 1, wherein each arm device includes a pump for increasing the flow from the flexible arm.

6. The system of claim 1, wherein the arm device includes a mill for converting crystalline hydrates into water and gas and/or a pump for dispersing coagulants in the presence of emulsifiers.

7. The system of claim 1, wherein each of the collecting units is in fluidic engagement with one of the at least two branching arms for collecting the flow from the at least two branching arms.

8. The system of claim 1, further comprising a bottomless vessel for each of the branching arms for transporting the flow from the branching arm to one of the collection units.

9. The system of claim 8, wherein each arm device includes a valve for regulating the flow to each branching arm for controlling when flow is received by each bottomless vessel.

10. The system of claim 1, further comprising a capping arrangement housed within the structure and including a metal frame housed within the structure for receiving a concrete mixture introduced through at least one regulation hole of the structure.

11. A system for extinguishing fire and diverting energy resources about a damaged wellhead or pipeline, comprising:
a bell-shaped, dome-like structure comprised of a single-layer or multi-layer flexible fire-proof material, the structure having at least one regulation hole therethrough for regulating pressure or fires therein;
at least two flexible arms in fluidic engagement with an apex of the structure for receiving flow from within the structure,
wherein each of the flexible arms is further in fluidic engagement with one of at least two distinct collection units; and
wherein each of the flexible arms includes an arm device for manipulating contents of the flow and a compensator for positioning the flexible arm.

12. The system of claim 11, wherein the structure further includes a circular pipe hole having a collar for hermetically sealing the structure about the damaged pipeline.

13. The system of claim 11, wherein:
the structure is modular and is further comprised of a plurality of sections coupled to each other using stitching, and
the structure further includes a circular pipe hole having a collar for hermetically sealing the structure about the damaged pipeline, and
two of the sections include semi-circular cutouts having semi-circular collar sections which, when the two sections are adjoined, form the pipe hole.

14. The system of claim 11, wherein each arm device includes a valve for regulating flow from the structure and/or amongst the flexible arms.

15. The system of claim 11, wherein each arm device further includes a pump for increasing the flow from the structure.

16. The system of claim 11, wherein the arm device further includes a mill for converting crystalline hydrates into water and gas and/or a pump for dispersing coagulants in the presence of emulsifiers.

17. The system of claim 11, wherein each of the collecting units is in fluidic engagement with one of the at least two flexible arms for collecting the flow from the at least two flexible arms.

18. The system of claim 11, further comprising a bottomless vessel for each of the flexible arms for transporting the flow from the flexible arm to one of the collection units.

19. The system of claim 18, wherein each arm device includes a valve for regulating the flow to each flexible arm for controlling when flow is received by each bottomless vessel.

20. The system of claim 11 further comprising a capping arrangement housed within the structure and including a metal frame housed within the structure for receiving a concrete mixture introduced through at least one regulation hole of the structure.

21. A method of extinguishing fire and diverting energy resources about a damaged wellhead or pipeline, comprising:
positioning a bell-shaped, dome-like structure comprised of flexible fire-proof material about the damaged wellhead or pipeline;
regulating pressure or fires within the structure by supplying inert materials or vapor and/or sealing the damaged wellhead or pipeline using concrete mixtures, through at least one regulation hole of the structure;
receiving flow from the damaged wellhead or pipeline through a flexible arm in fluidic engagement with an apex of the structure;
collecting the flow in at least two distinct collection units from at least two branching arms in fluidic engagement with the flexible arm; and
an arm device of each of the branching arms manipulating contents of the flow from the flexible arm.

22. The method of claim 21, wherein the collecting the flow in at least two distinct collection units includes using at least two bottomless vessels for transporting the flow released from the branching arms to the collection units and using valves of the arm device for regulating the flow between each of the branching arms and the bottomless vessels.
